(19) United States
(12) Patent Application Publication
(10) Pub. No.: US 2025/0219362 A1
(43) Pub. Date: Jul. 3, 2025

(54) SHORT CIRCUIT MITIGATION SYSTEM AND METHOD FOR HIGH VOLTAGE DISTRIBUTION SYSTEM

(71) Applicant: Dana Heavy Vehicle Systems Group, LLC, Maumee, OH (US)

(72) Inventors: David J. BERELS, Plymouth, MI (US); David HEIN, Sterling Heights, MI (US); Gordan JURASEK, Ann Arbor, MI (US)

(21) Appl. No.: 18/397,167

(22) Filed: Dec. 27, 2023

(51) Int. Cl. H02B 1/20; B60L 3/04

(52) U.S. Cl. CPC H02B 1/20; B60L 3/04

(57) ABSTRACT

Methods and systems for controlling electric power flow through an electric power distribution system of a vehicle are described. In one example, the electric power distribution system includes a plurality of batteries and a plurality of electric machines that are electrically coupled via a positive polarity bus bar and a negative polarity bus bar. One or both of the bus bars may be severed via an igniting agent operated device to reduce a possibility of degradation of the electric power distribution system.

### TECHNICAL FIELD

The present disclosure relates to mitigating effects of short circuits within a power distribution system.

### BACKGROUND AND SUMMARY

A vehicle may include a power distribution system that delivers electric power between electric power sources and electric power consumers. Additionally, the power distribution system may include input ports for a plurality of different charging systems to replenish the traction batteries with charge. The electric power sources, the electric power consumers, and the charging systems are part of a complex electric system that may make electric system circuit protection via fuses financially more expensive and difficult. In particular, high-power charging systems and multiple high energy batteries that may be applied in commercial vehicles may have hundreds of kilowatt hours of energy storage capacity and short circuit currents that may be in a range of between 30,000 and 100,000 amperes. Nevertheless, depending on the resistance of the short circuit, the short circuit current may be low enough to generate a reasonable fuse blow time, yet high enough to cause thermal degradation within the electric system. The wide range of short circuit currents that may result from either high or low short circuit resistances may cause a conventional fuse to not blow, or not blow in time, thereby providing a possibility of degradation within the electric power distribution system.

The inventors herein have recognized the above-mentioned issues and have developed an electric power distribution system, comprising: a positive polarity bus bar; a negative polarity bus bar; a current sensor integrated circuit including an over-current output; an igniting agent operated device; and an application specific integrated circuit (ASIC), the ASIC not including a central processing unit nor a processor, the ASIC directly electrically coupled to the over-current output, the ASIC directly electrically coupled to the igniting agent operated device.

By directly electrically coupling an electric current sensor integrated circuit to an ASIC that is directly electrically coupled to an igniting agent operated device, it may be possible to electrically decouple power sources from power consumers that are electrically coupled via an electric power distribution system so that a possibility of degradation of an electric power distribution system may be reduced. Since the electric current sensor is directly electrically coupled to the ASIC, and since the ASIC does not include a central processing unit, nor a processor, that uses processing time, an amount of time used to detect and response to electric current flow exceeding a threshold level may be reduced so that a possibility of electric power distribution system degradation may be reduced. Consequently, the electric current sensor, ASIC, and igniting agent operated device may mitigate short circuit conditions faster and more reliably than a system that includes fuses or a microcontroller.

The present description may provide several advantages. In particular, the approach may reduce a possibility of electric power distribution system degradation by quickly responding to electric current exceeding a threshold amount of electric current. Further, the approach provides for selected activation of igniting agent operated devices so that portions of the electric power distribution system may remain active, thereby allow a vehicle to continue to operate when possible. Additionally, the approach allows the threshold amount of electric current to be adjusted so that similar electric current sensing and control may be applied to different systems having different electric specifications.

It is to be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not restricted to implementations that solve any disadvantages noted above or in any part of this disclosure.

### BRIEF DESCRIPTION OF THE DRAWINGS

FIG. 1 is an illustration of an example vehicle that includes an electric power distribution system.

FIG. 2 shows one example electric power distribution system.

FIG. 3 shows a detailed view of an electric power distribution system electric current constraining circuit.

FIG. 4 shows an example electric power distribution electric current constraining sequence.

FIG. 5A shows details of a first example igniting agent operated device for constraining electric current flow through a bus bar.

FIG. 5B shows details of a second example igniting agent operated device for constraining electric current flow through a bus bar.

FIG. 6 shows a method for an electric power distribution system.

### DETAILED DESCRIPTION

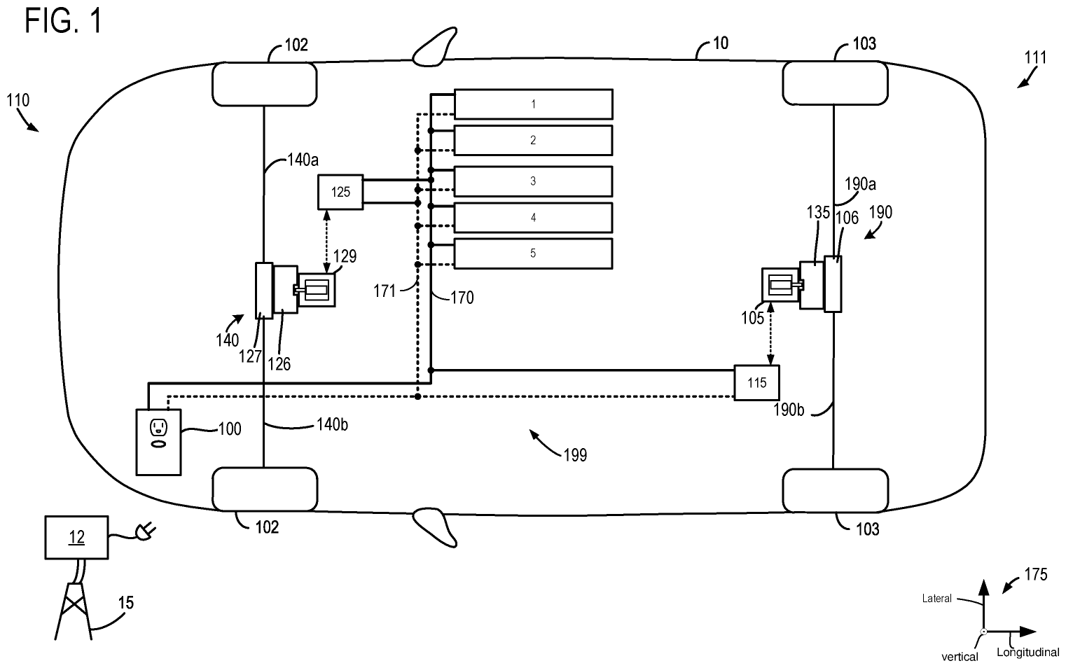

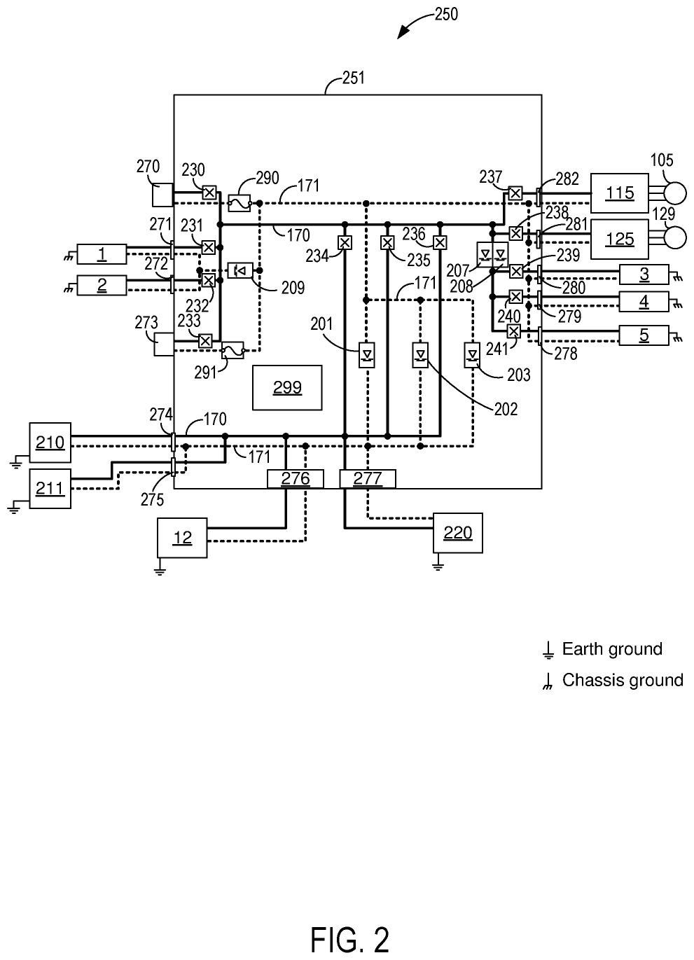

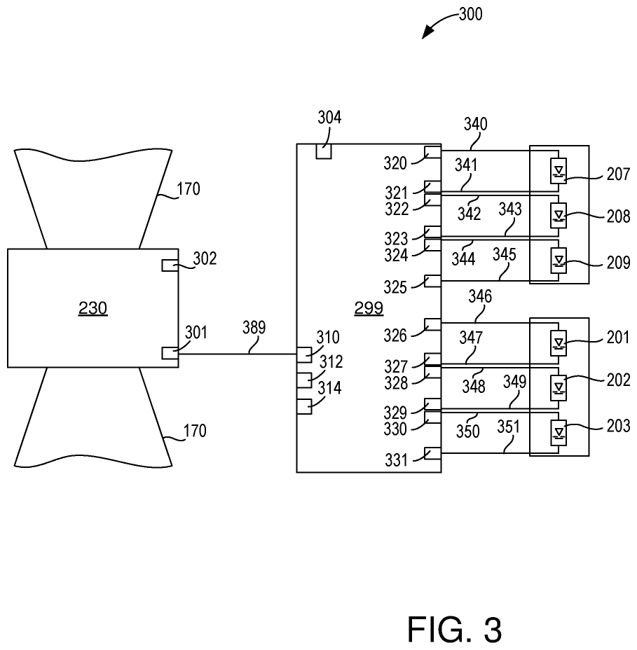

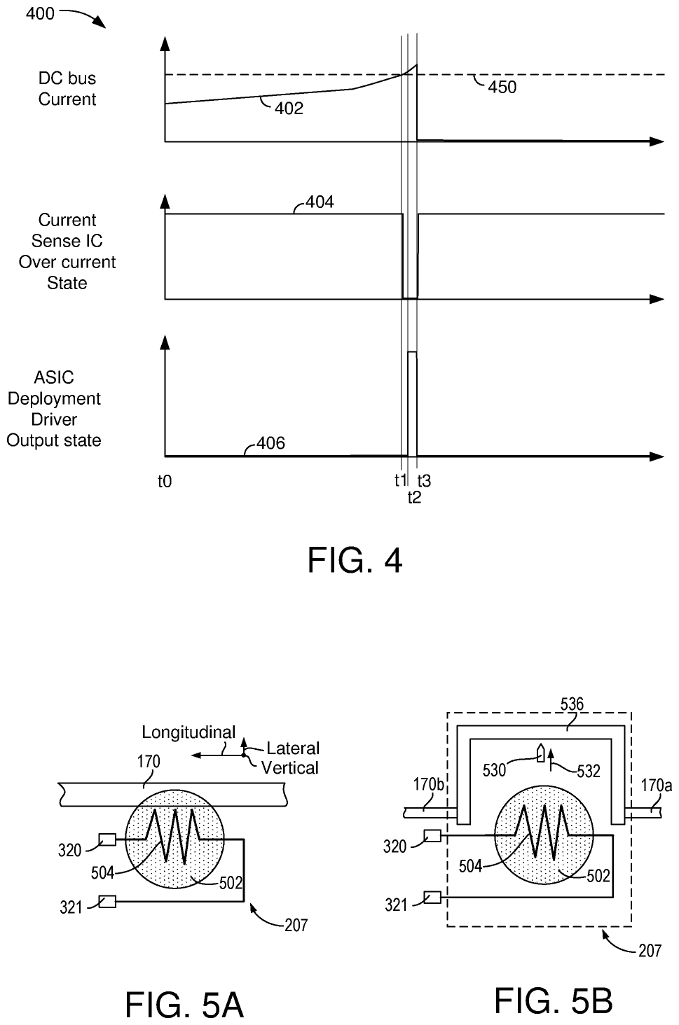

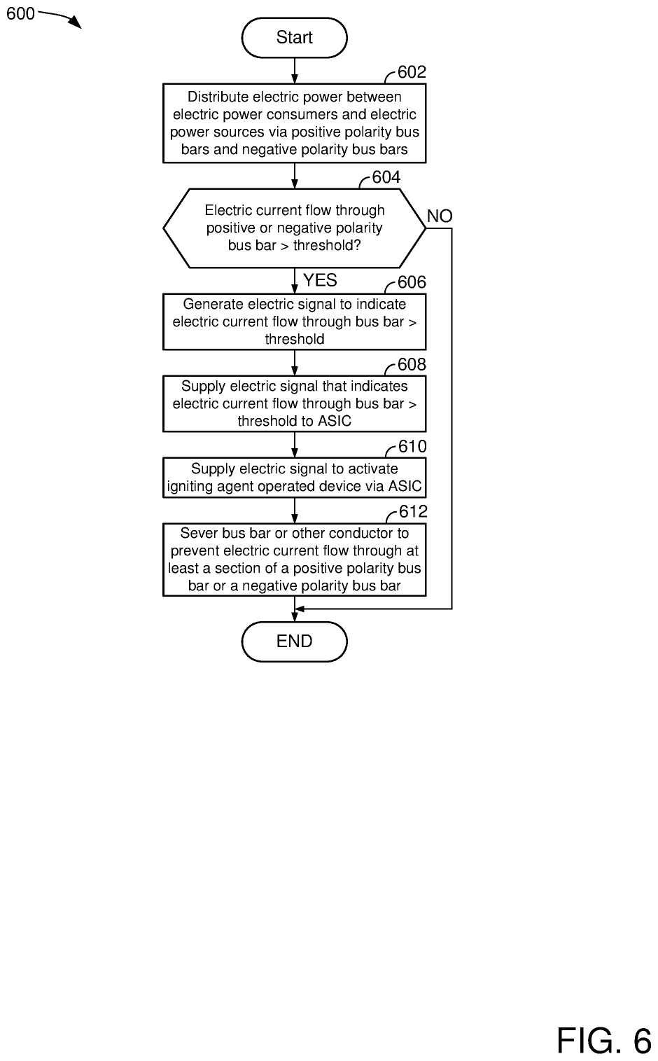

A method and system for controlling electric current flow through an electric power distribution system are described. The electric power distribution system may be incorporated in an electric vehicle or a hybrid vehicle as shown in FIG. 1. A detailed view of an example electric power distribution system is shown in FIG. 2. The example electric power distribution system includes bus bars that allow electric power to be transferred between electric power consumers and electric power sources. An example electric current constraining circuit for an electric power distribution system of a vehicle is shown in FIG. 3. The electric current constraining circuit may sever the bus bars to prevent electric current from flowing at higher than a threshold flow. An example electric current constraining sequence is shown in FIG. 4. The electric current may be constrained via an igniting agent operated device of the type shown in FIGS. 5A and 5B. Power may be distributed within a vehicle via the method of FIG. 6.

FIG. 1 illustrates an example vehicle electric power distribution system 199 for vehicle 10. The electric power distribution system 199 includes positive polarity bus bars 170 (e.g., bus bars that are configured to transfer electric power having a positive polarity) and negative polarity bus bars 171 (e.g., bus bars that are configured to transfer electric power having a negative polarity). The positive polarity bus bars 170 and the negative polarity bus bars 171 may be comprised of bars or strips of metal. The positive polarity bus bars 170 and negative polarity bus bars 171 may be electrically insulated from other electric power carrying conductors and nearby metallic surfaces and devices. The positive polarity bus bars 170 and negative polarity bus bars 171 may be included on a printed circuit board. Further, in some examples, the positive polarity bus bars 170 and negative polarity bus bars 171 may not be part of a printed circuit board. Rather, they may be metal conductors formed in the shape of bars, strips, cables, wires, or combinations thereof to electrically couple a plurality of electric power consumers and electric power sources of a vehicle. In still other examples, the positive polarity bus bars and the negative bus bars may comprise some conductors on a printed circuit board and other conductors that are not on the printed circuit board. The positive polarity bus bars 170 and the negative polarity bus bars 171 electrically couple a plurality of electric power sources and electric power consumers in vehicle 10.

Vehicle front end is indicated at 110 and vehicle rear end is indicated at 111. Vehicle 10 travels in a forward direction when vehicle front end 110 leads movement of vehicle 10. Vehicle 10 travels in a reverse direction when vehicle rear end 111 leads movement of vehicle 10. In this example, vehicle 10 is a four-wheel drive vehicle, but in other examples, vehicle 10 may be a two-wheel drive vehicle. Vehicle orientation is indicated via axis 175.

Vehicle 10 includes a first propulsion source 105 (e.g., an electric machine, such as a motor) and a second propulsion source 129. In one example, first propulsion source 105 and second propulsion source 129 may be synchronous or induction electric machines that may operate either as a motor or generator. In other examples, first propulsion source 105 and second propulsion source 129 may be a direct current (DC) machines. In this example, vehicle 10 also includes a transmission 135. The first propulsion source 105 is fastened to the first transmission 135 and first transmission 135 delivers power to first differential gears 106. First differential gears 106 may be coupled to two axle shafts, including a first or right axle shaft 190a and a second or left axle shaft 190b of rear axle 190. Similarly, the second propulsion source 129 is fastened to the second transmission 126 and second transmission 126 delivers power to second differential gears 127. Second differential gears 127 may be coupled to two axle shafts, including a first or right axle shaft 140a and a second or left axle shaft 140b of front axle 140. Vehicle 10 further includes front wheels 102 and rear wheels 103.

The first transmission 135 and second transmission 126 may be referred to as step ratio transmissions. First transmission 135 and second transmission 126 may each include one or more clutch actuators (not shown) to operate one or more clutches to change gears. First transmission 135 may transfer mechanical power to or receive mechanical power from first differential gears 106. Likewise, second transmission 126 may transfer mechanical power or receive mechanical power from second differential gears 127.

First propulsion source 105 may consume alternating current (AC) electrical power provided via first electric power inverter 115. Alternatively, first propulsion source 105 may provide AC electrical power to first electric power inverter 115 while vehicle 10 is being slowed. First electric power inverter 115 may be provided with high voltage (e.g., >400 volts) direct current (DC) power from electric energy storage devices 1-5 (e.g., traction batteries, which also may be referred to as battery packs). Likewise, second propulsion source 129 may consume alternating current (AC) electrical power provided via second electric power inverter 125. Alternatively, second propulsion source 129 may provide AC electrical power to second electric power inverter 125 while vehicle 10 is being slowed. Second electric power inverter 125 may be provided with high voltage (e.g., >400 volts) direct current (DC) power from electric energy storage devices 1-5 (e.g., traction batteries, which also may be referred to as battery packs). In this example, five electric energy storage devices are shown, but additional or fewer electric energy storage devices may be included and electrically coupled via positive polarity bus bars 170 and negative polarity bus bars 171.

First electric power inverter 115 is electrically coupled to first propulsion source 105 to convert DC power to alternating current (AC) and vise-versa. For example, first electric power inverter 115 may convert the DC electrical power from electric energy storage devices 1-5 into AC electrical power for propulsion source 105. Alternatively, first electric power inverter 115 may be provided with AC power from first propulsion source 105. First electric power inverter 115 may convert the AC electrical power from first propulsion source 105 into DC power to store in electric energy storage devices 1-5. Similarly, second electric power inverter 125 is electrically coupled to second propulsion source 129 to convert DC power to alternating current (AC) and vise-versa. For example, second electric power inverter 125 may convert the DC electrical power from electric energy storage devices 1-5 into AC electrical power for second propulsion source 129. Alternatively, second electric power inverter 125 may be provided with AC power from second propulsion source 129. Second electric power inverter 125 may convert the AC electrical power from second propulsion source 129 into DC power to store in electric energy storage devices 1-5.

Electric energy storage devices 1-5 may periodically receive electrical energy from a power source such as a stationary power grid 15 residing external to the vehicle (e.g., not part of the vehicle). As a non-restricted example, vehicle 10 may be configured as a plug-in electric vehicle (EV), whereby electrical energy may be supplied to electric energy storage devices 1-5 via the stationary power grid 15 and DC charger 12. Electric charge may be delivered to electric energy storage devices 1-5 via plug receptacle 100.

Turning now to FIG. 2, an example non-constrained electric power distribution system 250 is shown. Electric power distribution system 250 includes positive polarity bus bars 170 and negative polarity bus bars 171. The positive and negative polarity bus bars support power transfer between power sources and power consumers. The positive and negative bus bars may include a plurality of conductors that make up the bus bars and allow electric current to flow between different devices. In this example, power sources include DC chargers (e.g., DC charger 12, DC charger 210, and DC charger 211), DC megawatt charger 220, and electric energy storage devices 1-5, and first propulsion source 105 and second propulsion source 129 when the propulsion sources are operating as generators while converting the vehicle's kinetic energy into electric energy. The power consumers include first propulsion source 105 and second propulsion source 129 when the propulsion sources are operating as motors to propel the vehicle. Electric energy storage devices 1-5 may also operate as electric power consumers during regenerative braking. The first propulsion source 105 is electrically coupled to the electric power distribution system 250 via first electric power inverter 115. The second propulsion source 129 is electrically coupled to the electric power distribution system 250 via second electric power inverter 125.

Electric power sources and power consumers may be electrically coupled to the electric power distribution system 250 via connectors. For example, electric energy storage devices 1-5 are electrically coupled to the electric power distribution system 250 via connectors 271, 272, 278, 279, and 280. First electric power inverter 115 is electrically coupled to electric power distribution system 250 via connector 282. Second electric power inverter 125 is electrically coupled to electric power distribution system 250 via connector 281. DC charger 210 is electrically coupled to electric power distribution system 250 via connector 274. DC charger 211 is electrically coupled to electric power distribution system 250 via connector 275. DC charger 12 is electrically coupled to electric power distribution system 250 via connector 276. DC megawatt charger 220 is electrically coupled to electric power distribution system 250 via connector 277. Connector 270 is electrically coupled to electric power distribution system 250 to provide an access port for electric power takeoff. Connector 273 is electrically coupled to electric power distribution system 250 to provide an auxiliary access port.

Electric power distribution system 250 includes a plurality of electric current sensor integrated circuits that measure electric current flow. Each of the electric current sensor integrated circuits may be proximate to either the negative polarity bus bars 171 or positive polarity bus bars 170. Electric current sensor integrated circuit 230 is positioned to measure electric current flow to connector 270 (an electric power takeoff port), which indicates electric current flow to an electric power takeoff device (not shown). Electric current sensor integrated circuit 231 is positioned to measure electric current flow to and from connector 271 and electric energy storage device 1. Electric current sensor integrated circuit 232 is positioned to measure electric current flow to and from connector 272 and electric energy storage device 2. Electric current sensor integrated circuit 233 is positioned to measure electric current flow to connector 273 (an auxiliary port), which indicates electric current flow to an auxiliary device (not shown). Electric current sensor integrated circuit 232 is positioned to measure electric current flow to and from connector 272 and electric energy storage device 2. Electric current sensor integrated circuits 234, 235, and 236 are positioned to measure electric current flow from DC charger 210, DC charger 211, DC charger 12, and DC megawatt charger 220. Electric current sensor integrated circuit 237 is positioned to measure electric current flow to and from connector 282 and first propulsion source 105. Electric current sensor integrated circuit 238 is positioned to measure electric current flow to and from connector 281 and second propulsion source 129. Electric current sensor integrated circuit 239 is positioned to measure electric current flow to and from connector 280 and electric energy storage device 3. Electric current sensor integrated circuit 240 is positioned to measure electric current flow to and from connector 279 and electric energy storage device 4. Electric current sensor integrated circuit 241 is positioned to measure electric current flow to and from connector 278 and electric energy storage device 5.

Electric power distribution system 250 also includes igniting agent operated devices (e.g., squibs) 201, 202, 203, 207, 208, and 209. In this example, igniting agent operated devices 201, 202, 203, 207, 208, and 209 may be configured to prevent electric current flow through negative polarity bus bars 171 or positive polarity bus bars 170. In particular, igniting agent operated devices 209, 201, 202, and 203 are arranged and/or configured to selectively prevent electric current flow through negative polarity bus bars 171 when activated. On the other hand, igniting agent operated devices 207 and 208 are arranged to selectively prevent electric current flow through positive polarity bus bars 170 when activated. Igniting agent operating devices may be in physical contact with positive polarity bus bars 170 and/or negative polarity bus bars 171 so that if an igniting agent operating device is activated, it physical severs the positive or negative polarity bus bar when electric current flows through the igniting agent operating device causing the igniting agent to generate pressure and heat that cause the positive or negative polarity bus bar to be severed. Alternatively, as shown in FIG. 5B, each of the igniting agent operating devices may include a conductor that allows electric current to flow through each igniting agent operating device where the conductor bridges a gap between sections of the positive or negative polarity bus bar. The conductor may be severed by igniting an igniting agent within the igniting agent operating device, which causes a cutter to sever the conductor in the igniting agent operating device, thereby constraining electric current flow through the positive or negative polarity bus bar.

Electric power distribution system 250 also includes an application specific integrated circuit (ASIC) 299. The ASIC 299 does not include a central processing unit. Rather, ASIC 299 includes sensor interfaces and deployment drivers for activating the ignition agent operated devices that allow ASIC 299 to activate ignition agent operated devices without central processor delays. The ASIC 299 is directly electrically coupled to electric current sensor integrated circuits 230-241 (e.g., no intervening integrated circuits between the current sensor and the ASIC, but there may be passive devices (resistors, capacitors) between the ASIC and the electric current sensor) and to the ignition agent operated devices. ASIC 299 may activate one or more of the ignition agent operated devices in response to output from one or more of the electric current sensor integrated circuits. Further, ASIC 299 may be programed to activate selected ignition agent operated devices in response to outputs of the electric current sensor integrated circuits.

In one example, the electric current sensor integrated circuits may include a Hall effect electric current sensor and a programmable output that indicates electric current flowing through a conductor (e.g., a positive or a negative polarity bus bar) exceeding a threshold, where the threshold is programmable.

In this example, electric power distribution system 250 also includes fuse 290 and fuse 291 to constrain electric current flow to or from connector 270 and connector 273. These fuses may constrain electric current flow to electric power takeoff devices (not shown) and auxiliary devices (not shown).

Electric current may flow through portions of negative polarity bus bars 171 and positive polarity bus bars 170 bi-directionally depending on whether devices that are electrically coupled to the electric power distribution system 250 are operating as power sources or consumers. The electric power distribution system 250 may include a printed circuit board 251 and ASIC 299, electric current sensor integrated circuits, and igniting agent operated devices may be located on printed circuit board 251. Alternatively, electric power distribution system 250 may or may not include a printed circuit board and the bus bars may or may not be included on the printed circuit board.

Referring now to FIG. 3, a detailed plan view of an electric power distribution system electric current constraining circuit 300 for a vehicle is shown. Electric current constraining circuit 300 includes details of components that were previously discussed in the description of FIG. 2. The electric power distribution system electric current constraining circuit includes electric current sensor integrated circuit 230 and it is placed over positive polarity bus bar 170. Electric current sensor integrated circuit 230 includes a programming port 302 that allows a user to select an electric current threshold that when exceeded by electric current flowing through positive polarity bus bar 170 causes over-current output 301 or fault output to change state (e.g., from a higher voltage to a lower voltage, or vice-versa). Over-current output 301 is directly electrically coupled to input 310 of ASIC 299 (e.g., there are no intervening integrated circuits between electric current sensor integrated circuit 230 and ASIC 299, but there may be passive devices between the electric current sensor integrated circuit and the ASIC) via conductor 389.

ASIC 299 includes a plurality of electric current sensor integrated circuit inputs 310-314 and a plurality of deployment driver outputs (320-331) for activating igniting agent operated devices (201, 202, 203, 207, 208, 209). ASIC 299 also includes a programming port 304 to program a voltage level at the input causes activation of the deployment driver outputs. Further, via the programming port 304, activation of particular deployment drivers and their corresponding igniting agent operated devices may be mapped to over-current signals that are supplied to the ASIC inputs. For example, an over-current signal at one input of the ASIC may activate one deployment driver, while an over-current signal at a different input of the ASIC may activate three different deployment drivers and their corresponding igniting agent operated devices. The ASIC is directly coupled to the igniting agent operated devices via conductors 340-351 (e.g., no intervening integrated circuits between the igniting agent operated devices and the ASIC, but there may be passive devices (resistors, capacitors) between the ASIC and the igniting agent operated devices).

Referring now to FIG. 4, an example electric power distribution current constraining sequence is shown. The sequence of FIG. 4 may be generated by the system of FIGS. 1-3. The plots of FIG. 4 are aligned in time and the vertical lines represent times of interest in the sequence.

The first plot from the top of FIG. 4 is a plot of DC bus bar electric current versus time. The vertical axis represents DC bus bar electric current and DC bus bar electric current increases in the direction of the vertical axis arrow. The horizontal axis represents time and time increases from the left side of the plot to the right side of the plot. Trace 402 represents the DC bus bar electric current. Dashed line 450 represents a threshold amount of current flow through the bus bar that is the basis for constraining electric current flow through the DC bus bar.

The second plot from the top of FIG. 4 is a plot of electric current sense integrated circuit (IC) over-current state versus time. The vertical axis represents electric current sense integrated circuit over-current state and the electric current sense integrated circuit over-current state is not indicating an over-current state when trace 404 (e.g., represents an electric signal) is at a higher level that is near the vertical axis arrow. The electric current sense integrated circuit over-current state is indicating an over-current state when trace 404 is at a lower level that is near the horizontal axis. The horizontal axis represents time and time increases from the left side of the plot to the right side of the plot. Trace 404 represents electric current sense integrated circuit over-current state.

The third plot from the top of FIG. 4 is a plot of the deployment driver operating state of ASIC 299 versus time. The vertical axis represents deployment driver state and the deployment driver is not activated when trace 406 (e.g., represents an electric signal) is at a lower level that is near the horizontal axis. The deployment driver is activated so that the igniting agent operated device may prevent electric current flow through at least a portion of a bus bar. The horizontal axis represents time and time increases from the left side of the plot to the right side of the plot. Trace 404 represents the operating state of the deployment driver of the ASIC.

At time t0, electric current flow through the DC bus bar is less than threshold 450 so the electric current sense integrated circuit does not indicate an over-current condition. The ASIC deployment driver is not activated.

At time t1, the electric current flow through the DC bus bar exceeds threshold 450. This cause the electric current integrated circuit over-current output state to switch from a higher level to a lower level shortly after time t1. An over-current condition is now indicated to the ASIC. The ASIC deployment driver state is changed from a lower level to a higher level shortly thereafter at time t2. This heats the igniting agent operated device (not shown) and the igniting agent operating device releases energy from an igniting agent to sever a section of the DC bus bar.

At time t3, electric current flow through the bus bar has ceased so the current sensing integrated circuit indicates low current flow, which causes the deployment driver of the ASIC to a low state. The entire time duration between time t1 and time t3 may be less than 1 millisecond as compared to a micro-controller solution, which may take up to 500 milliseconds. Thus, the circuitry and system describe herein may provide greater protection of electric circuits when current flow rates are higher.

Turning now to FIG. 5A, an example of a first igniting agent operated device is shown. Igniting agent operated device 207 includes an ignition element 504 (e.g. a resistive heating device) that is in physical contact with an igniting agent 502. The ignition element 504 is electrically coupled to deployment driver outputs 320 and 321. Ignition element 504 may generate heat when the deployment driver outputs send electric current through the ignition element 504. The heated ignition element 504 may ignite the igniting agent 502 so that the igniting agent generates pressure and heat. The pressure and heat may sever bus bar in a lateral direction as indicated to prevent electric current from flowing through positive polarity bus bar 170. In one example, igniting agent operated device 207 may be positioned under positive polarity bus bar 170 to sever the positive polarity bus bar when activated.

Referring now to FIG. 5B, an example of a second igniting agent operated device is shown. Similar to the first igniting agent operated device, igniting agent operated device 207 includes an ignition element 504 (e.g. a resistive heating device) that is in physical contact with an igniting agent 502. Further, the ignition element 504 is electrically coupled to deployment driver outputs 320 and 321. However, in this example, second igniting agent operated device includes a conductor 536 and a cutting device 530. Ignition element 504 may generate heat when the deployment driver outputs send electric current through the ignition element 504. The heated ignition element 504 may ignite the igniting agent 502 so that the igniting agent generates pressure and heat, which pushes cutting device 530 into conductor 536, severing conductor 536 so that electric current may be prevented from passing from a first section 170a of positive polarity bus bar 170 to a second section 170b of positive polarity bus bar 170, thereby protecting the positive polarity bus bar from higher electric currents.

The system of FIGS. 1-3, 5A, and 5B provides for an electric power distribution system, comprising: a positive polarity bus bar; a negative polarity bus bar; a current sensor integrated circuit including an over-current output; an igniting agent operated device; and an application specific integrated circuit (ASIC), the ASIC not including a central processing unit, the ASIC directly electrically coupled to the over-current output, the ASIC directly electrically coupled to the igniting agent operated device. In a first example, the electric power distribution system includes where the positive polarity bus bar includes a plurality of conductors. In a second example that may include the first example, the electric power distribution system includes where the current sensor integrated circuit is arranged proximate to one of the plurality of conductors to sense electric current in the one of the plurality of conductors. In a third example that may include one or both of the first and second examples, the electric power distribution system includes where the negative polarity bus bar includes a plurality of conductors. In a fourth example that may include one or more of the first through third examples, the electric power distribution system includes where the current sensor integrated circuit is arranged proximate to one of the plurality of conductors to sense electric current in the one of the plurality of conductors. In a fifth example that may include one or more of the first through fourth examples, the electric power distribution system includes where the igniting agent operated device is positioned to sever the positive polarity bus bar or the negative polarity bus bar when activated. In a sixth example that may include one or more of the first through fifth examples, the electric power distribution system includes where the current sensor integrated circuit is configured to change a state of the over-current output in response to a predetermined amount of electric current flowing through the positive polarity bus bar or the negative polarity bus bar. In a seventh example that may include one or more of the first through sixth examples, the electric power distribution system includes where the ASIC is configured to activate the igniting agent operated device in response to the state of the over-current output.

The system of FIGS. 1-3, 5A, and 5B also provides for an electric power distribution system, comprising: a positive polarity bus bar comprising a plurality of conductors; a negative polarity bus bar comprising a plurality of conductors; a plurality of current sensor integrated circuits including over-current outputs; a plurality of igniting agent operated devices; and an application specific integrated circuit (ASIC), the ASIC not including a central processing unit, the ASIC directly electrically coupled to the over-current outputs, the ASIC directly electrically coupled to the plurality of igniting agent operated devices. In a first example, the electric power distribution system includes where the plurality of igniting agent operated devices includes two igniting agent operated devices configured to sever the positive polarity bus bar along a same lateral section of the positive polarity bus bar. In a second example that may include the first example, the electric power distribution system includes where the plurality of igniting agent operated devices includes a first group of igniting agent operated devices and a second group of igniting agent operated devices, and where the first group of igniting agent operated devices is configured to electrically decouple electric vehicle supply equipment from electric machines and batteries. In a third example that may include one or both of the first and second examples, the electric power distribution system includes where the second group of igniting agent operated devices is configured to electrically decouple the batteries from the electric machines and the electric vehicle supply equipment. In a fourth example that may include one or more of the first through third examples, the electric power distribution system further comprises a plurality of traction batteries, and where the plurality of current sensor integrated circuits includes one current sensor for each of the plurality of traction batteries.

Moving on the FIG. 6, a method for an electric power distribution system of a vehicle is shown. The method of FIG. 6 may be performed in the real world via the components of the system shown in FIGS. 1-3, 5A, and 5B changing state and reacting to various signals.

At 602, method 600 distributes electric power in a vehicle between electric power consumers (e.g., electric machines, batteries, etc.) and electric power sources (e.g., DC chargers, batteries, etc.). The electric power may be distributed via positive and negative polarity bus bars. Method 600 proceeds to 604.

At 604, method 600 judges whether or not an amount of electric current flowing through a portion or section of a positive or negative polarity bus bar is greater than a threshold amount of current. If so, the answer is yes and method 600 proceeds to 606. Otherwise, the answer is no and method 600 proceeds to exit. Method 600 may measure electric current flow via an electric current sensor (e.g., 230 of FIG. 2).

At 606, method 600 generates an electric signal to indicate electric current flow through a positive or negative polarity bus bar is greater than a threshold. In one example, a current sensing integrated circuit may generate the electric signal. Method 600 proceeds to 608.

At 608, method 600 supplies or transfers the electric signal that indicates electric current flow through the positive or negative polarity bus bar is greater than a threshold to an ASIC (e.g., 299 of FIG. 2) via a conductor. Method 600 proceeds to 610.

At 610, method 600 supplies an electric signal to activate an igniting agent operated device (e.g., a squib). The ASIC may supply the electric signal via a conductor to the igniting agent device with no intervening integrated circuits. The signal activates the igniting agent device. Method 600 proceeds to 612.

At 612, method 600 severs a positive polarity bus bar or a negative polarity bus bar or a device that electrically couples two sections of a positive polarity bus bar or negative polarity bus bar. The severing may be performed by the igniting agent applying pressure to an area of a bus bar or via a cutting device. Thus, electric current flow through at least a section of a positive polarity or negative polarity bus bar may be ceased. Method 600 proceeds to exit.

In this way, the method of FIG. 6 provides for a method for an electric power distribution system, comprising: distributing electric power between a plurality of power sources and a plurality of power consumers via a positive polarity bus bar and a negative polarity bus bar; and severing at least one of the positive polarity bus bar and the negative polarity bus bar via an igniting agent operated device, the igniting agent operated device activated via an application specific integrated circuit (ASIC), the ASIC not including a central processing unit. In a first example, the method includes where the severing is performed in response to an electric current flowing through the positive polarity bus bar or the negative polarity bus bar exceeding a threshold electric current. In a second that may include the first example, the method further comprises detecting the electric current flowing through the positive polarity bus bar or the negative bus bar via an electric current sensor integrated circuit. In a third example that may include one or both of the first and second examples, the method further comprises generating an indication of electric current flowing through the positive polarity bus bar or the negative polarity bus bar exceeding a threshold current via an output of the electric current sensor integrated circuit. In a fourth example that may include one or more of the first through third examples, the method includes where the indication is an electric signal, and further comprising supplying the electric signal to the ASIC. In a fifth example that may include one or more of the first through fourth examples, the method includes where severing the at least one of the positive polarity bus bar and the negative polarity bus bar includes severing the positive polarity bus bar and the negative bus bar. In a sixth example that may include one or more of the first through fifth examples, the method further comprises activating a second igniting agent operated device to sever the positive polarity bus bar.

Note that the example control and estimation routines included herein can be used with various powertrain and/or vehicle system configurations. The control methods and routines disclosed herein may be stored as executable instructions in non-transitory memory and may be carried out by the control system including the controller in combination with the various sensors, actuators, and other transmission and/or vehicle hardware. Further, portions of the methods may be physical actions taken in the real world to change a state of a device. Thus, the described actions, operations and/or functions may graphically represent code to be programmed into non-transitory memory of the computer readable storage medium in the vehicle and/or transmission control system. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. One or more of the method steps described herein may be omitted if desired.

While various embodiments have been described above, it is to be understood that they have been presented by way of example, and not constrained. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a constraining sense, because numerous variations are possible. For example, the above technology can be applied to electric vehicles and hybrid vehicles including induction and synchronous electric machines. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric power distribution system, comprising:
a positive polarity bus bar;
a negative polarity bus bar;
a current sensor integrated circuit including an over-current output;
an igniting agent operated device; and
an application specific integrated circuit (ASIC), the ASIC not including a central processing unit, the ASIC directly electrically coupled to the over-current output, the ASIC directly electrically coupled to the igniting agent operated device.

2. The electric power distribution system of claim 1, where the positive polarity bus bar includes a plurality of conductors.

3. The electric power distribution system of claim 2, where the current sensor integrated circuit is arranged proximate to one of the plurality of conductors to sense electric current in the one of the plurality of conductors.

4. The electric power distribution system of claim 1, where the negative polarity bus bar includes a plurality of conductors.

5. The electric power distribution system of claim 4, where the current sensor integrated circuit is arranged proximate to one of the plurality of conductors to sense electric current in the one of the plurality of conductors.

6. The electric power distribution system of claim 1, where the igniting agent operated device is positioned to sever the positive polarity bus bar or the negative polarity bus bar when activated.

7. The electric power distribution system of claim 1, where the current sensor integrated circuit is configured to change a state of the over-current output in response to a predetermined amount of electric current flowing through the positive polarity bus bar or the negative polarity bus bar.

8. The electric power distribution system of claim 7, where the ASIC is configured to activate the igniting agent operated device in response to the state of the over-current output.

9. A method for an electric power distribution system, comprising:
distributing electric power between a plurality of power sources and a plurality of power consumers via a positive polarity bus bar and a negative polarity bus bar; and
severing at least one of the positive polarity bus bar and the negative polarity bus bar via an igniting agent operated device, the igniting agent operated device activated via an application specific integrated circuit (ASIC), the ASIC not including a central processing unit.

10. The method of claim 9, where the severing is performed in response to an electric current flowing through the positive polarity bus bar or the negative polarity bus bar exceeding a threshold electric current.

11. The method of claim 10, further detecting the electric current flowing through the positive polarity bus bar or the negative polarity bus bar via an electric current sensor integrated circuit.

12. The method of claim 11, further comprising generating an indication of electric current flowing through the positive polarity bus bar or the negative polarity bus bar exceeding a threshold current via an output of the electric current sensor integrated circuit.

13. The method of claim 12, where the indication is an electric signal, and further comprising supplying the electric signal to the ASIC.

14. The method of claim 9, where severing the at least one of the positive polarity bus bar and the negative polarity bus bar includes severing the positive polarity bus bar and the negative polarity bus bar.

15. The method of claim 9, further comprising activating a second igniting agent operated device to sever the positive polarity bus bar.

16. An electric power distribution system, comprising:
a positive polarity bus bar comprising a plurality of conductors;
a negative polarity bus bar comprising a second plurality of conductors;
a plurality of current sensor integrated circuits including over-current outputs;
a plurality of igniting agent operated devices; and
an application specific integrated circuit (ASIC), the ASIC not including a central processing unit, the ASIC directly electrically coupled to the over-current outputs, the ASIC directly electrically coupled to the plurality of igniting agent operated devices.

17. The electric power distribution system of claim 16, where the plurality of igniting agent operated devices includes two igniting agent operated devices configured to sever the positive polarity bus bar along a same lateral section of the positive polarity bus bar.

18. The electric power distribution system of claim 16, where the plurality of igniting agent operated devices includes a first group of igniting agent operated devices and a second group of igniting agent operated devices, and where the first group of igniting agent operated devices is configured to electrically decouple electric vehicle supply equipment from electric machines and batteries.

19. The electric power distribution system of claim 18, where the second group of igniting agent operated devices is configured to electrically decouple the batteries from the electric machines and the electric vehicle supply equipment.

20. The electric power distribution system of claim 16, further comprising a plurality of traction batteries, and where the plurality of current sensor integrated circuits includes one current sensor for each of the plurality of traction batteries.
